(19) United States
(12) Patent Application Publication
(10) Pub. No.: US 2009/0132238 A1
(43) Pub. Date: May 21, 2009

(54) EFFICIENT METHOD FOR REUSING SCALE FACTORS TO IMPROVE THE EFFICIENCY OF AN AUDIO ENCODER

(76) Inventor: B. SUDHAKAR, Bangalore (IN)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/263,229

(22) Filed: Oct. 31, 2008

(30) Foreign Application Priority Data
Nov. 2, 2007 (IN) 2495/CHE/2007

(51) Int. Cl. G10L 21/00; G10L 19/00

(52) U.S. Cl. 704/200.1; 704/500; 704/E21.001

(57) ABSTRACT

An audio encoding system that accepts an audio signal as an input to the system. The system includes a filter bank that splits the audio signal into a plurality of frames, and a bit allocation unit that assigns a number of bits for a current frame of the plurality of frames. The system further includes a scale factor unit that calculates a scale factor, identifies a block type of a first block of a current frame, identifies a block type of a second block consecutive to the first block, and reuses a scale factor of the first block for the second block, when the block type of the first block and the block type of the second block match. The system additionally includes a quantization and coding unit that quantizes and codes the signal, and a bit rate checker that verifies whether a bit rate requirement is satisfied.

### CROSS REFERENCE TO RELATED APPLICATIONS

This application claims the benefit of priority under 35 USC § 119 from Indian Patent Application No. 2495/CHE/2007, filed Nov. 2, 2007, the entire contents of which are incorporated herein by reference.

### BACKGROUND

1. Technical Field

Some embodiments of the present invention relate to the field of audio signal processing. More particularly, an exemplary embodiment relates to improving the efficiency of an audio encoder.

2. Description of the Related Art

Audio processing refers to the processing of sound represented in the form of analog or digital signals. Analog signals are continuous electrical signals, in which a voltage level or a current level represents a sound. In digital signals, a sound wave is represented by binary symbols, i.e., in the form of 1s or 0s. Sound signals are continuous signals, so they must be converted to digital signals by quantizing and sampling the signals. Digital signals offer advantages such as ease of processing and ease of editing as compared to analog signals.

The psychoacoustic model is based on the science of psycho-acoustics, which is the study of human sound perception, and plays an important role in audio compression. Human hearing has an absolute hearing threshold, which changes significantly with frequency. Sounds with a volume below the threshold cannot be heard. The human hearing system processes sound in sub-bands called critical bands. In each critical band, sound is analyzed independently, and a critical bandwidth differs within a frequency range. Also, an important part of psycho-acoustic study is the effect of masking. Masking refers to the effect in which the human ear cannot perceive some tone components of an audio signal. Masking curves, which depend on a masking frequency, are defined for maskers, and all sounds below the masking curves will be inaudible. Masking determines which frequency components can be discarded or more highly compressed in audio compression.

In an encoder, an audio stream is passed through a filter bank that divides the stream into multiple sub-bands of frequency. The input audio stream simultaneously passes through a psycho-acoustic model that determines a ratio of the signal energy to the masking threshold for each sub-band, by calculating average amplitudes for each sub-band, obtaining corresponding hearing thresholds, and discarding the frequencies below the threshold as inaudible. The audio stream is then passed onto a quantizer. In the quantizer, the following steps are performed:

a) Initial scale factors are calculated from the thresholds and the energy levels of the psycho-acoustic model.

b) The quantization noise to be introduced while encoding spectral values is calculated. Quantization noise refers to the noise introduced during the process of quantization and is the difference between an original signal and its quantized signal.

c) The bits per step of increase of the global gain is calculated. The global gain is a common multiplying factor for all of the scale factors, and an increase in the global gain results in a decrease in a required number of bits.

d) A rate control loop is performed. In the rate control loop, a check is kept on a bit used by assigning shorter code words to more frequently quantized values.

Steps a, b, and c form a noise loop. The noise loop checks if the quantization noise produced is well within a limit. If the quantization noise is above the limit, then there will be audible noise. An encoder relies on the noise loop and the rate control loop to calculate the final scale factors. For each block, a scale factor has to be recalculated, resulting in high memory consumption during the process.

FIG. 1 shows a process of two nested iteration loops, used for quantization and encoding. The optimum gain and scale factors for a given block and bit rate are output from the perceptual model usually by the following two nested iteration loops in an analysis-by-synthesis way.

In the inner iteration loop, also called the rate control loop, if the number of bits resulting from the coding exceeds the number of bits available for coding a given block of data, the discrepancy is corrected by adjusting the global gain to result in a larger quantization step size, leading to smaller quantized values. This operation is repeated with different quantization step sizes until the resulting bit demand for Huffman coding is small enough.

In the outer iteration loop, also called the noise control or distortion loop, scale factors are applied to each scale factor band to shape the quantization noise according to the masking threshold. If the quantization noise in a given band is found to exceed the masking threshold, the scale factor for this band is adjusted to reduce the quantization noise. Since achieving a smaller quantization noise requires a larger number of quantization steps and thus a higher bit rate, the rate adjustment loop has to be repeated every time. In other words, the rate loop is nested within the noise control loop. The outer loop is executed until the actual noise is below the masking threshold for every scale factor band.

U.S. Pat. No. 6,725,192 talks about an audio coding and quantization method. That patent talks about scale factor band-wise quantization, where a quantizer step size of a band is calculated based on a bit allocated for a sub-band. Bits are allocated for each scale factor band according to an allowed distortion level, which is an output of the psycho-acoustic model. This coding method is suitable only for Advanced Audio Coding (AAC) and is not suitable for MPEG 1 Audio Layer 3 (MP3).

### BRIEF SUMMARY

There is a need for an efficient coding method, which is suitable for any audio encoder, that utilizes iteration loops for encoding methods like MP3 and AAC and that reduces the computing power required for the process of audio encoding. An exemplary embodiment does away with the noise loop and hence, by reducing the processing required for quantization, increases a speed of the audio encoder.

An object of an exemplary embodiment is to optimize an audio encoder. This method makes use of the fact that an audio signal does not change in its signal characteristics within a very short span of time. This property is utilized to reduce the computation required for a calculation of scale factors. The same method can be applied to a psychoacoustic model and a PNS (Perceptual Noise Substitution) decision to optimize the encoder. The method is very generic and can be adapted for use with any audio encoder.

Accordingly, one exemplary embodiment reuses calculated scale factors from a previous block. A scale factor can be reused provided that the present block is the same as the previous block and a number of times the scale factor has been reused is less than a predetermined value.

Another exemplary embodiment can be used in encoders where granule level processing is used, such as MP3 encoders, where the granules can be adjusted to have a same block type and so, permit reuse of the scale factors.

Further objects, features, and advantages will become apparent from the following description, claims, and drawings.

### BRIEF DESCRIPTION OF THE DRAWINGS

The above aspects are described in detail with reference to the attached drawings, where:

FIG. 1 shows the existing process of two nested iteration loops, used for quantization and encoding.

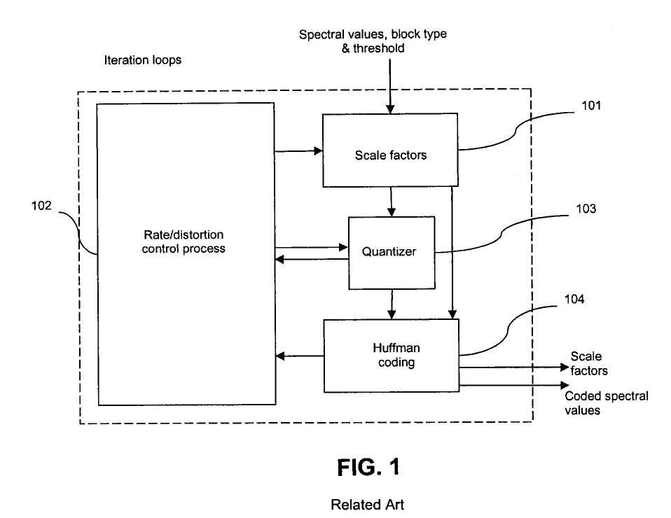

FIG. 2 shows a block diagram of an audio encoder, utilizing the scale factor reuse method.

FIG. 3 depicts a system flow of a process of audio encoding, utilizing a scale factor reuse method.

FIG. 4 depicts a flow diagram of a process of quantization using a concept of scale factor reuse.

FIG. 5 shows a process flow for scale factor reuse.

FIG. 6 shows a flowchart of conditions under which scale factors may be reused.

FIG. 7 shows a flowchart of how scale factors may be reused.

FIG. 8 shows a basic block diagram of a System-on-a-Chip (SoC).

FIG. 9 shows a typical working scenario, where scale factor reuse is implemented.

### DETAILED DESCRIPTION

In an audio signal, the signal characteristics will change heavily over time only if the signal's amplitude and frequency increase within a very short time. For example, while processing a signal sampled at 44.1 KHz, an encoder has to process about 43 frames/sec. In such a case, the time difference between two consecutive frames is 0.02321 sec, which is a very short amount of time. Thus, a variation in signal characteristics cannot be perceived by a normal listener. So, the computation done in one frame can be safely used as a starting point for another frame, provided that the block type is the same. While processing the signal, the computation required to calculate the scale factors can be reduced significantly, as an audio signal does not change in its signal characteristics within a very short span of time.

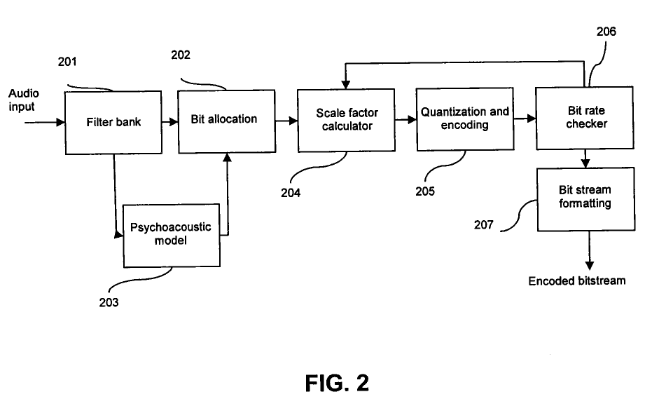

FIG. 2 shows a block diagram of an audio encoder that utilizes a scale factor reuse method. An input audio signal is passed through a filter bank (201) that splits the signals into frames. Simultaneously, the input signal is passed through a psychoacoustic model (203) that models the hearing characteristics of the human ear. In the bit allocation block (202), the bits to be consumed in the current frame of the signal are calculated according to a sampling frequency, a bit rate, and bits in the reservoir. The next block (204) verifies if the scale factors from the previous block can be reused. In the case of a negative answer, the scale factors are calculated in this block (204). Quantization and coding are performed in the next block (205). The signals are quantized and then coded using Huffman tables. The bit rate is checked to see if the bit rate requirement is met (206). If the bit rate requirement is not met, the scale factors are modified in block (204) and the stream is passed through the process once more. In the bit stream formatting block (207), the header, bit allocation information, scale factors, and sample codes are combined into a bitstream.

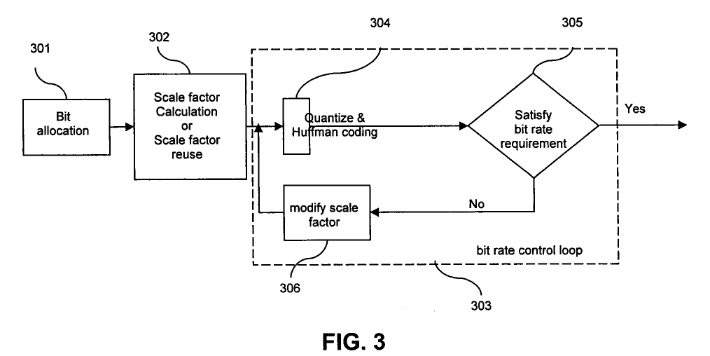

FIG. 3 shows a flow diagram of a process of quantization using a concept of scale factor reuse. In the first step (301), the bits to be consumed in the current frame are calculated according to the sampling frequency, the bit rate, and bits in the reservoir. In step (302), a scale factor calculation or a determination whether the reuse of a scale factor is possible is performed. A scale factor calculation is performed for the first frame and is calculated using Modified Discrete Cosine Transform (MDCT) energy values. Once the scale factors are calculated, quantization and Huffman coding are performed, and the MDCT values are quantized with the scale factors and coded with the Huffman tables (304). The bit rate is then checked to see if the bit rate meets the bit rate requirement (305). If it meets the requirement, then the scale factors, the quantized values, and the Huffman tables are passed onto the bit stream formatter. If the bit rate is less than the required bit rate, the scale factors are modified (306) to satisfy the bit rate requirement, and the quantization and the Huffman coding are performed once again. The process of quantization and coding (304), checking the bit rate requirement (305), and modifying the bit rate (306) is called a bit rate control loop (303).

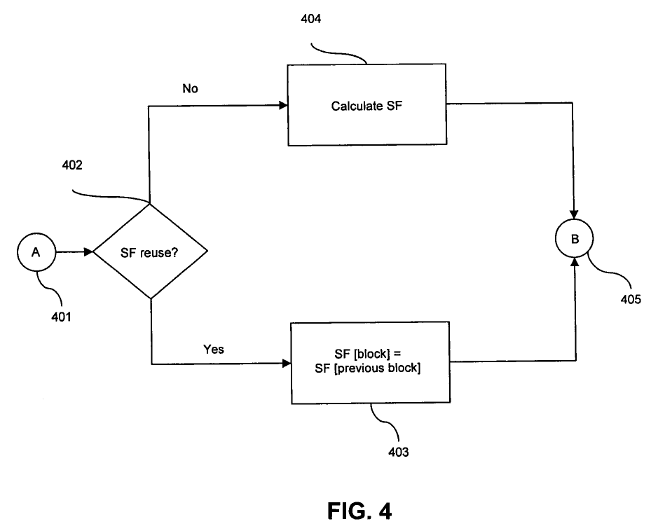

FIG. 4 shows a flow for scale factor reuse. Start 401 represents inputs to the system, i.e., the MDCT values and the scale factors of the previous block. In step 402, the decision whether the scale factor is to be reused is made. If so, the scale factor of the current block is set the same as the scale factor of the previous block (403). If not, the scale factor is recalculated (404). The scale factors are then output (405) to other quantization blocks.

The scale factor of each band is calculated from the MDCT energy of the band. A scale factor reuse method is employed to reduce the peak MCPS (Megachips per second), i.e., the processing clock cycles. In this method, if you consider a block in a frame, this block will attempt to use the scale factor of the previous block, to avoid scale factor recalculation. This reduces the number of rate control loops. In order to reuse the scale factor of one block in another block, both of the blocks should be of the same block type. The various types of blocks are Long blocks (0—normal, 1—start block, and 3—stop block) and short blocks (2).

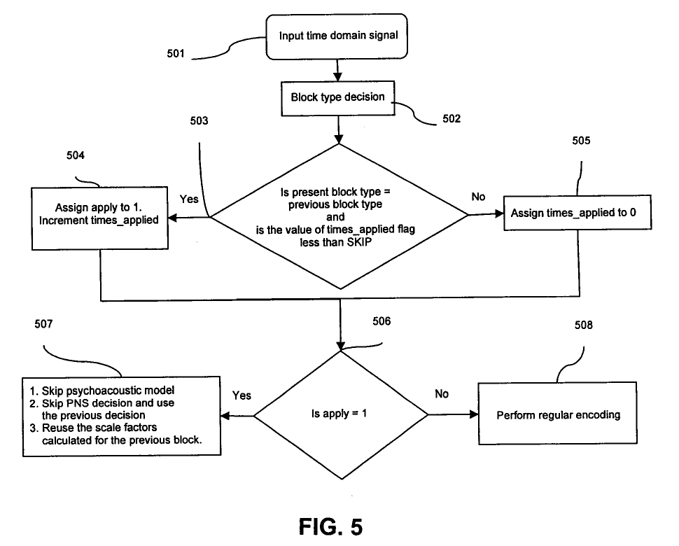

FIG. 5 shows a flowchart of conditions under which scale factors may be reused. The input is a time domain signal (501). Then a type of the present block is decided (502). In the next step, it is checked if the present block type is the same as the previous block type and if a number of times the scale factor has been reused, e.g., “times_applied,” is less than a value, e.g., SKIP (503). The value of SKIP has been set to 2 because a number of times that the scale factor ideally can be skipped without degradation in quality is 2. If the conditions mentioned in (503) are satisfied, then an apply flag is set to 1 and “times_applied” is incremented (504). If the conditions mentioned in (503) are not satisfied, then “times_applied” is assigned the value 0 (505). In step (506), it is checked if the value of the apply flag is equal to 1. If the apply flag is not equal to 1, then regular encoding is performed (508). If the apply flag is equal to 1, then the psychoacoustic model is skipped, the PNS decision is skipped and the previous decision is used, and the scale factors calculated for the previous block are reused (507).

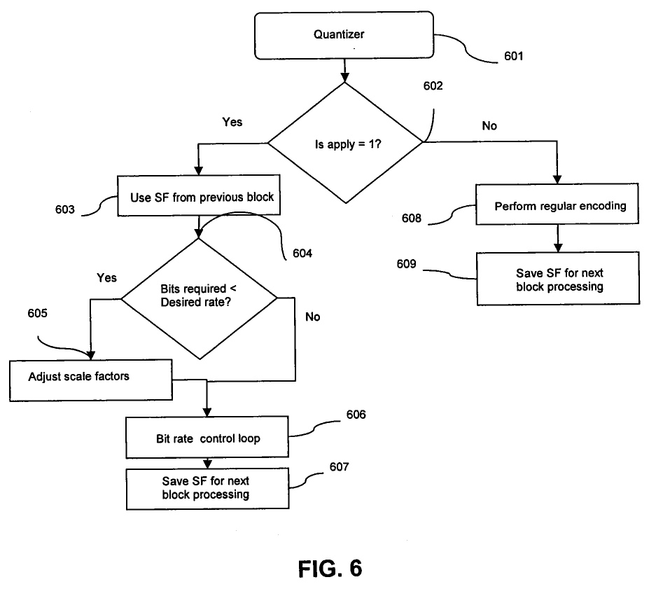

FIG. 6 shows a flowchart of how the scale factors are reused. The input from the quantizer (601) is checked to see if the apply flag is equal to 1 (602). If the apply flag is equal to 1, then the scale factors from the previous block are used (603). The bits required are compared to the desired rate to see if the bits required are less than the desired rate (604). If the bits required are less than the desired rate, then the scale factors are adjusted (605). Once the scale factors have been adjusted, if needed, then the bit rate control loop is performed (606) and the scale factors of the present block are saved for using in processing the next block (607). If the apply flag is not equal to 1, then regular encoding is performed (608) and the scale factors are saved for processing the next block (609).

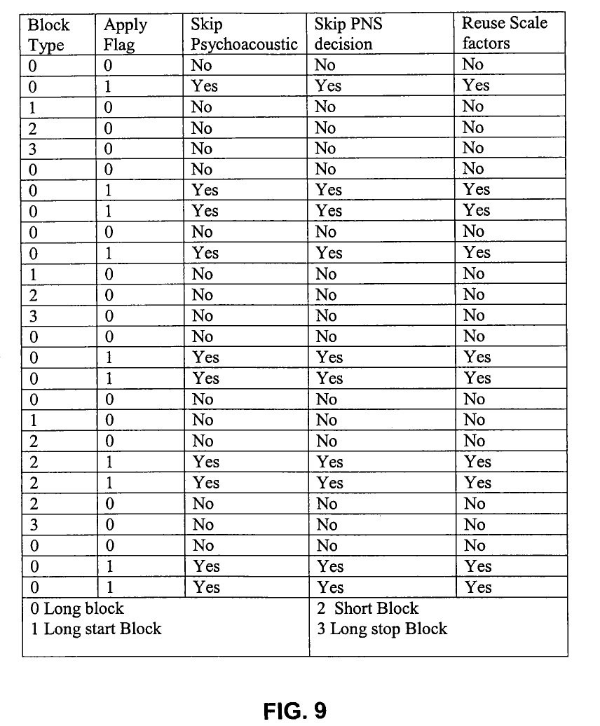

FIG. 9 shows a typical working scenario, where scale factor reuse is implemented, and where the block type is initially checked and then the apply flag is checked. If the present block type is the same as the previous block type, then the psychoacoustic model and the PNS decision are skipped and the scale factors are reused.

The concept of scale factor reuse can also be used in encoders where granule level processing is used, such as an MP3 encoder. In MP3s, a single frame is made up of 2 granules, referred henceforth as GR1 and GR2, respectively. Block type manipulation is performed to ensure that the block type of both granules is the same. This ensures that the scale factors of GR1 can be reused for GR2. For example, if the block type of GR1 is 2 and the block type of GR2 is 3, then the block type of GR2 is modified to 2. This aids in enabling scale factor reuse in all of the frames.

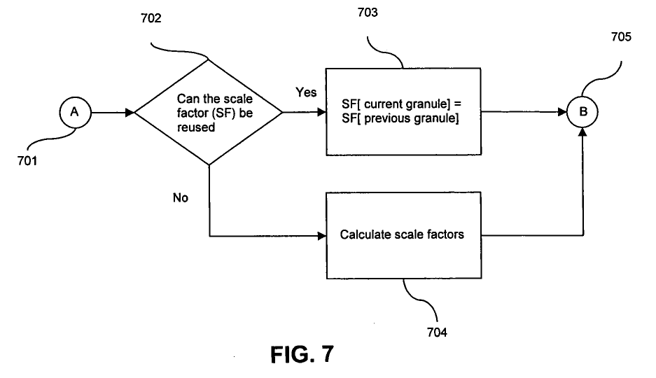

FIG. 7 shows a concept of scale factor reuse in a case of granule processing. Input A (701) is input from the previous modules and includes MDCT values and scale factors of a previous granule. In step 702, the decision is made whether the scale factors can be reused. If so, then the scale factor of the previous granule is reused, and the scale factor of the current granule is set the same as the scale factor of the previous granule (703). If the scale factor from the previous granule cannot be reused, the scale factor is calculated (704). The scale factor of the current granule is output to the quantizer (705).

Applying a method of scale factor reuse in encoders aids in reducing the peak MCPS. Since the scale factor of the current granule is the same as the scale factor of the previous granule, a number of rate control loops performed is reduced. Also, in the case of MP3s, the average MCPS within a frame is maintained at the same level.

The scale factor reuse method is very generic and can be adapted to work with any type of encoder.

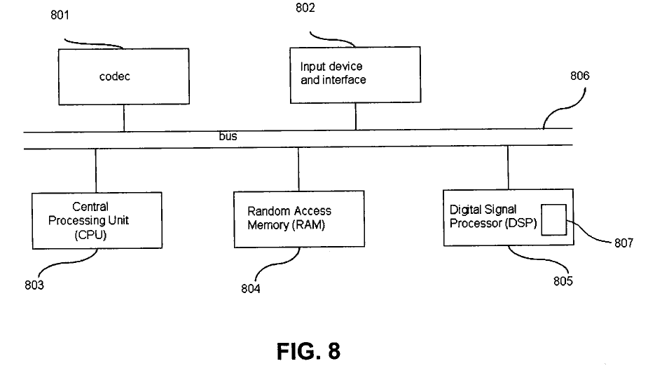

A basic block diagram of System-on-a-Chip (SoC) is as shown in FIG. 8. The SoC or other implementation includes one or more codecs (801), an input device and user interface (802), a central processing unit (CPU) (803), a random access memory (804), a digital signal processing unit (DSP) (805), and a bus to enable communication between these modules (806). The input device and user interface (802) are connected to input and output devices like keypads, touch screens, LCDs, and so on. Codecs (801) are used to convert an analog sound signal into the digital domain. The CPU (803) provides commands to the other modules to perform operations on the signal, and the RAM (804) provides the memory necessary for conducting the audio processing. The audio encoding system module (807) resides in the DSP (805) and processes the time domain input signal. This SoC finds applications in portable audio players, television systems, and music systems. The random access memory may include computer executable instructions, which, when executed by the CPU, cause the CPU to perform the processing described previously.

Although the present invention has been described with particular reference to specific examples, variations and modifications of the present invention can be effected within the spirit and scope of the following claims.

1. An audio encoding system, comprising:
a filter bank configured to divide an audio signal into a plurality of frames;
a bit allocation unit configured to assign a number of bits for a current frame of the plurality of frames;
a scale factor unit configured to
calculate a scale factor,
identify a block type of a first block of the current frame,
identify a block type of a second block consecutive to the first block, and
reuse a scale factor of the first block for the second block, when the block type of the first block and the block type of the second block match;
a quantization and coding unit configured to quantize and code the audio signal;
a bit rate checker configured to verify whether a bit rate requirement is satisfied; and
a bit stream formatting unit configured to create a bit stream.

2. The system as claimed in claim 1, further comprising:
a psychoacoustic modeling unit configured to model hearing characteristics of a human ear.

3. The system as claimed in claim 1, wherein the scale factor unit is configured to reuse the scale factor a maximum of two times.

4. The system as claimed in claim 2, wherein the scale factor unit is configured to enable a flag when the block type of the second block is the same as the block type of the first block and a number of times the scale factor has been reused is less than a predetermined number.

5. The system as claimed in claim 4, wherein the scale factor unit is configured to enable the flag when the number of times the scale factor has been reused is less than 2.

6. The system as claimed in claim 4, wherein the scale factor unit is configured to increment the number of times the scale factor has been reused by one, when the block type of the second block is the same as the block type of the first block and the number of times the scale factor has been reused is less than the predetermined number.

7. The system as claimed in claim 4, wherein when the flag is enabled, the psycho-acoustic modeling unit does not calculate a psycho-acoustic analysis of a block, and a perceptual noise substitution decision is not made.

8. The system as claimed in claim 1, wherein when the bit rate checker verifies that the bit rate requirement is not satisfied, the scale factor unit modifies the scale factor, and the quantization and coding unit performs low level quantization and coding.

9. The system as claimed in claim 1, wherein when the system is performing granule level processing, the system performs block type manipulation to set a block type of a first granule to a block type of a second granule.

10. A method for encoding a frame of an audio signal, comprising:
identifying a block type of a first block of the frame;
identifying a block type of a second block consecutive to the first block; and
reusing a scale factor of the first block for the second block, when the block type of the first block and the block type of the second block match.

11. The method as claimed in claim 10, wherein the reusing reuses the scale factor a maximum of two times.

12. The method as claimed in claim 10, further comprising:
enabling a flag, when the block type of the second block is the same as the block type of the first block and a number of times the scale factor has been reused is less than a predetermined number.

13. The method as claimed in claim 12, wherein the predetermined number is 2.

14. The method as claimed in claim 12, further comprising:
incrementing the number of times the scale factor has been reused by one, when the block type of the second block is the same as the block type of the first block and the number of times the scale factor has been reused is less than the predetermined number.

15. The method as claimed in claim 12, wherein when the flag is enabled, a calculation of a psycho-acoustic analysis of a block is not performed, and a perceptual noise substitution decision is not made.

16. The method as claimed in claim 10, further comprising:
modifying the scale factor and performing low level quantization and coding, when a bit rate requirement is not met.

17. The method as claimed in claim 10, further comprising:
performing block type manipulation to set a block type of a first granule to a block type of a second granule, in a case of granule level processing.
